(19) United States
(12) Patent Application Publication
(10) Pub. No.: US 2016/0267273 A1
(43) Pub. Date: Sep. 15, 2016

(54) SOFTWARE UPDATE APPARATUS AND COMPUTER-READABLE STORAGE MEDIUM STORING SOFTWARE UPDATE PROGRAM

(71) Applicant: MITSUBISHI ELECTRIC CORPORATION, Tokyo (JP)

(72) Inventor: Takeshi SUGAWARA, Tokyo (JP)

(73) Assignee: MITSUBISHI ELECTRIC CORPORATION, Tokyo (JP)

(21) Appl. No.: 15/034,788

(22) PCT Filed: Nov. 6, 2013
(86) PCT No.: PCT/JP2013/079986

§ 371 Date: May 5, 2016

(51) Int. Cl. G06F 21/57; H04L 9/06; H04L 9/32; G06F 21/51; G06F 9/445

(52) U.S. Cl. CPC G06F 21/572; G06F 21/51; G06F 8/65; H04L 9/3236; H04L 9/0637; G06F 2221/033

(57) ABSTRACT

An object of the present invention is to allow software to be securely updated when a volatile memory that will become a working area is not sufficiently large. An embedded apparatus sequentially performs a verification process on each of a plurality of sections obtained by division of update data for updating the software. The embedded apparatus stores an intermediate value obtained during the verification process. When the verification process is completed for each of the sections, the embedded apparatus compares a value obtained in the verification processes with verification data to check that there is no tampering. When it can be confirmed that there is no tampering, the embedded apparatus sequentially performs the verification process on each section again. The embedded apparatus compares an intermediate value obtained during the verification process with the intermediate value stored, and updates the software using the section when the intermediate value obtained and the intermediate value stored are the same.

### TECHNICAL FIELD

The present invention relates to a technology for securely updating software such as firmware using update data.

### BACKGROUND ART

Software that defines an operation of an embedded apparatus is referred to as firmware.

Updating the firmware allows defect correction and function addition to be implemented after product shipment. When the update can be implemented by an end user on that occasion, product recall is not necessary. Thus, generally, a firmware update function by the end user is provided for the embedded apparatus.

A general procedure for updating the firmware by the end user is constituted from the following (1) to (3):
(1) the end user acquires update data from a web site of a manufacturer;
(2) the update data is input to the embedded apparatus of a target through wired communication or a recording medium; and
(3) the embedded apparatus rewrites the firmware based on the update data.

When the firmware update function is implemented in the embedded apparatus, a malicious end user may input altered update data to the embedded apparatus of the target in order to modify the embedded apparatus, for example. If such modification has been implemented, a security function included in the embedded apparatus may be circumvented. As a result, the manufacturer of the embedded apparatus may suffer damage such as illegal copying or counterfeit product manufacture.

Thus, a technology is needed which prevents arbitrary firmware alteration in an embedded apparatus where firmware may be updated.

Non-Patent Literature 1 describes the technology that prevents arbitrary firmware alteration using an encryption technology. Non-Patent Literature 1 applies detection of tampering of a message using a digital signature or a message authentication code to firmware protection.

### CITATION LIST

### Non-Patent Literature

Non-Patent Literature 1: RFC4108, “Using Cryptographic Message Syntax (CMS) to Protect Firmware Packages”,
http://tools.ietf.org/html/rfc4108

Non-Patent Literature 2: E. Fleischmann, C. Forler, S. Lucks, and J. Wenzel, “McOE: A Family of Almost Foolproof On-Line Authenticated Encryption Schemes”, Cryptology ePrint Archive: Report 2011/644

Non-Patent Literature 3: A. J. Menezes, P. C. van Oorschot, and S. A. Vanstone, “Handbook of Applied Cryptography”, 2001.

Non-Patent Literature 4: G. Bertoni, J. Daemen, M. Peters, and G. Van Assche, “On the Indifferentiability of the Sponge Construction”, Eurocrypt 2008.

Non-Patent Literature 5: NIST, “Recommendation for Block Cipher Modes of Operation: Galois/Counter Mode (GCM) for Confidentiality and Authentication,” Draft Special Publication 800-38D, April 2006.

### SUMMARY OF INVENTION

### Technical Problem

When the tampering detection technology is applied to the firmware protection as described in Non-Patent Literature 1, a verification process for performing tampering detection needs to be performed in an embedded apparatus in which firmware is to be updated.

A volatile memory that will become a working area needs to be sufficiently large in order to securely implement this verification process. If an apparatus has a high-performance CPU, this requirement is generally satisfied. However, in case of the embedded apparatus which is comparatively low-performance, this requirement may not be satisfied. In case of a CPU including a flash ROM (one-chip microcomputer), in particular, the volatile memory generally has a smaller capacity than a non-volatile memory. Thus, this requirement may often be unsatisfied.

An object of the present invention is to allow software such as firmware to be securely updated when a volatile memory that will become a working area is not sufficiently large.

### Solution to Problem

A software update apparatus according to the present invention may include:

a data acquisition unit to sequentially acquire each of a plurality of divided update data obtained by division of update data for updating software;

a verification unit to execute a verification process on the divided update data acquired by the data acquisition unit;

an intermediate value storage unit to store an intermediate value obtained during the verification process executed by the verification unit;

a data reacquisition unit to sequentially acquire each of the divided update data again when the verification process is finished for each of the divided updated data and verification of the update data succeeds;

a re-verification unit to execute the verification process on the divided update data acquired by the data reacquisition unit; and an update unit to update the software using the divided update data acquired by the data reacquisition unit when an intermediate value obtained during the verification process executed by the re-verification unit and the intermediate value stored by the intermediate value storage unit are the same.

### Advantageous Effects of Invention

In the software update apparatus according to the present invention, the verification process is not performed on the update data all at once. The verification process is performed for each of the plurality of divided update data obtained by the division of the update data. Thus, even if a volatile memory that will become a working area is small, the verification process may be performed.

Further, in the software update apparatus according to the present invention, the verification process is sequentially performed on each divided update data to check that each divided update data is not tampered with and the intermediate value obtained during the verification process is stored. Then, when each divided update data is confirmed not to be tampered with, the verification process is sequentially performed again on each divided update data. Then, it is checked that the intermediate value obtained and the intermediate value stored before are the same. When it is confirmed that the intermediate value obtained and the intermediate value stored before are the same, the software is updated. Consequently, a fraudulent conduct may also be prevented in which after the verification process has been finished once, the software is updated using the divided update data that has been tampered with.

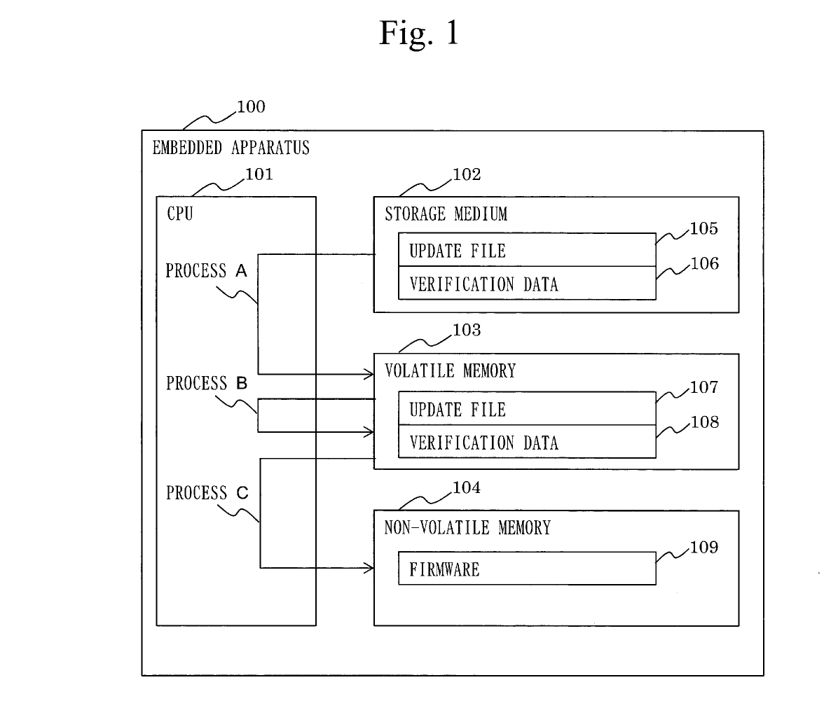

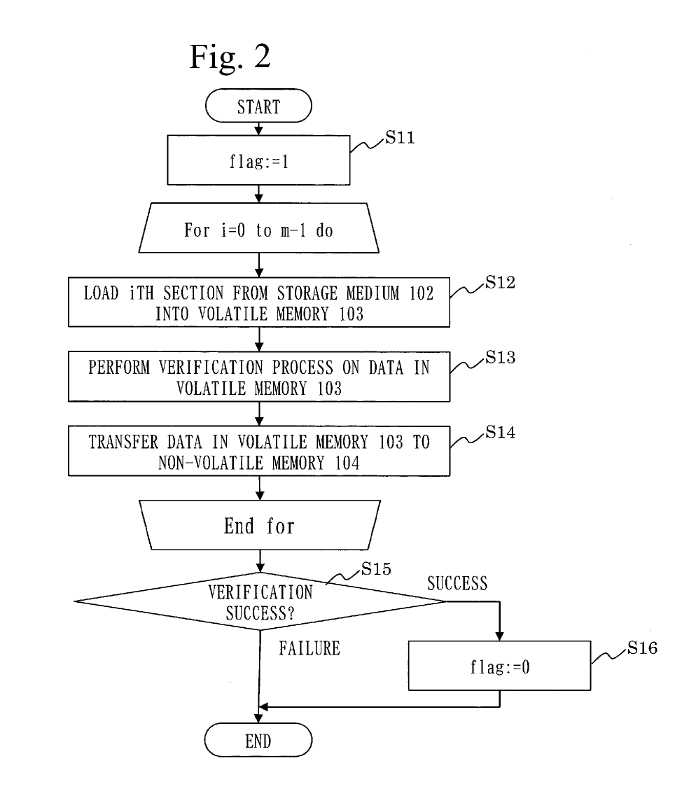

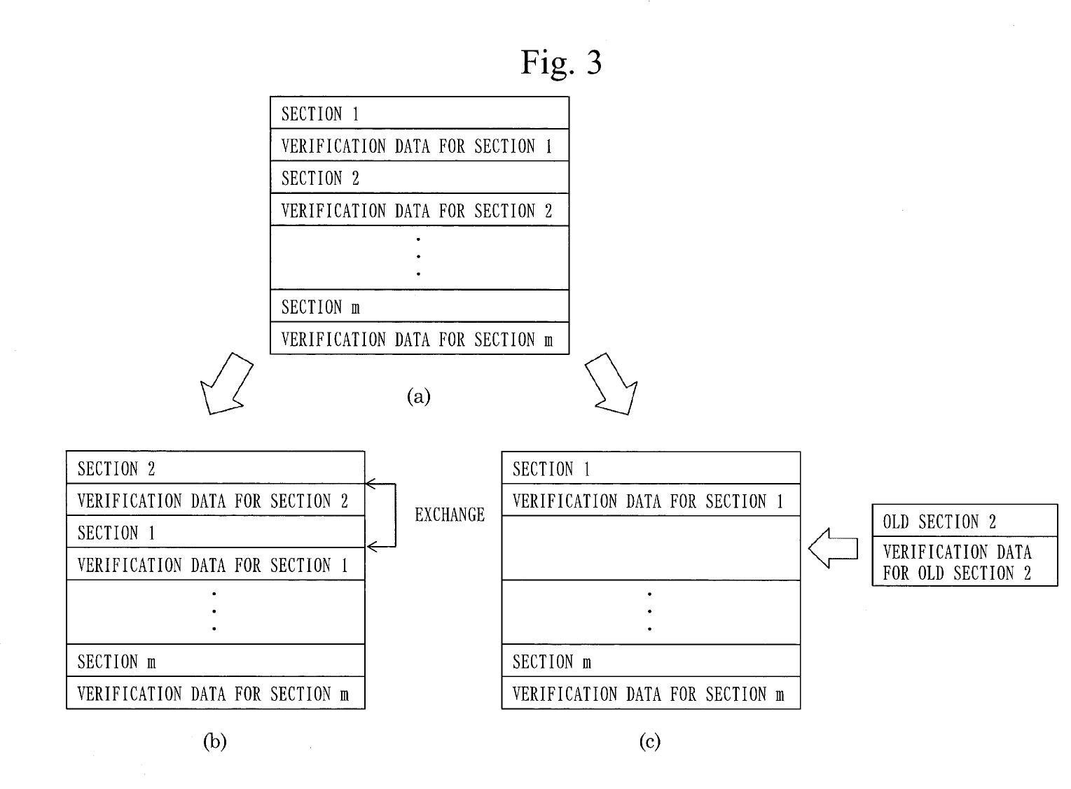

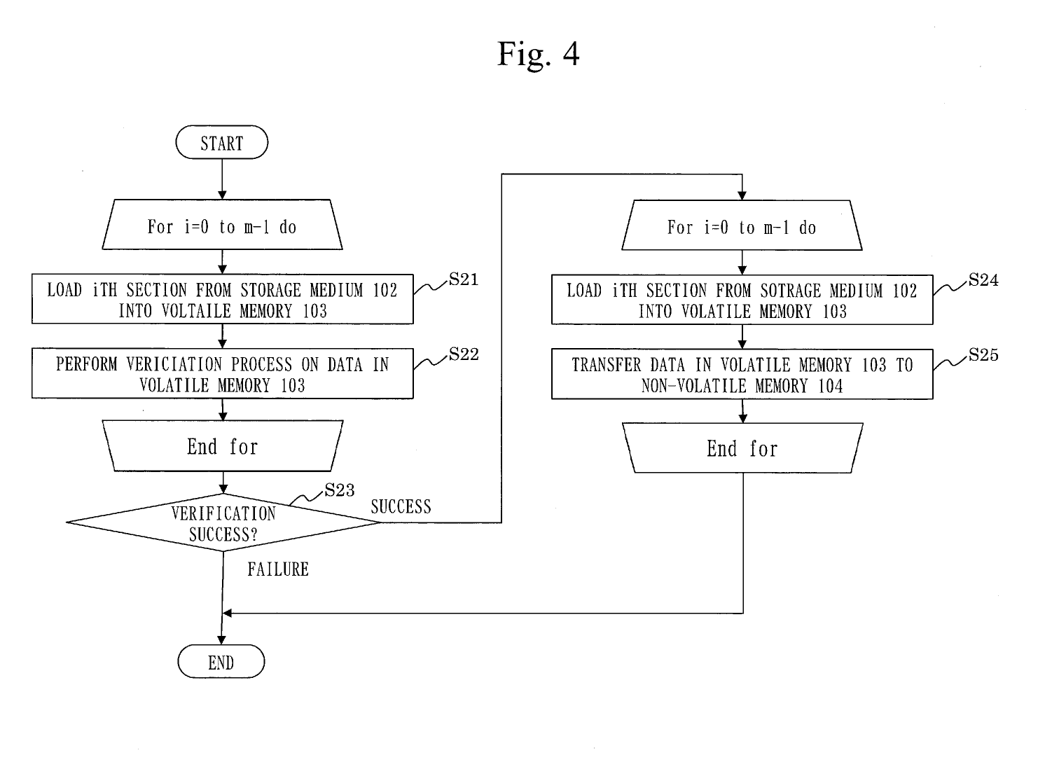

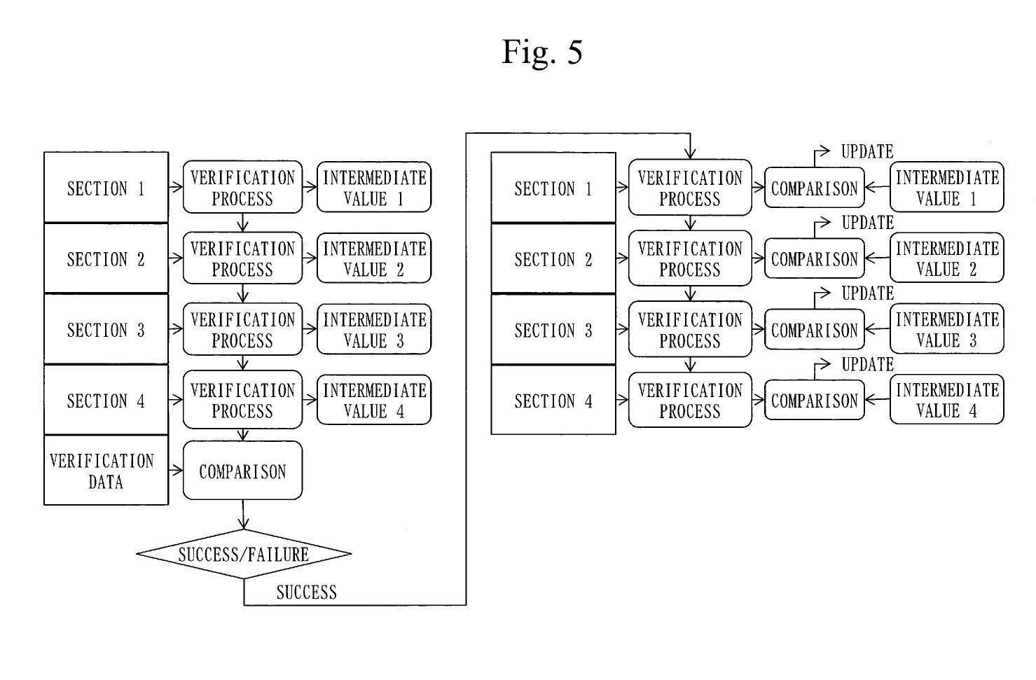

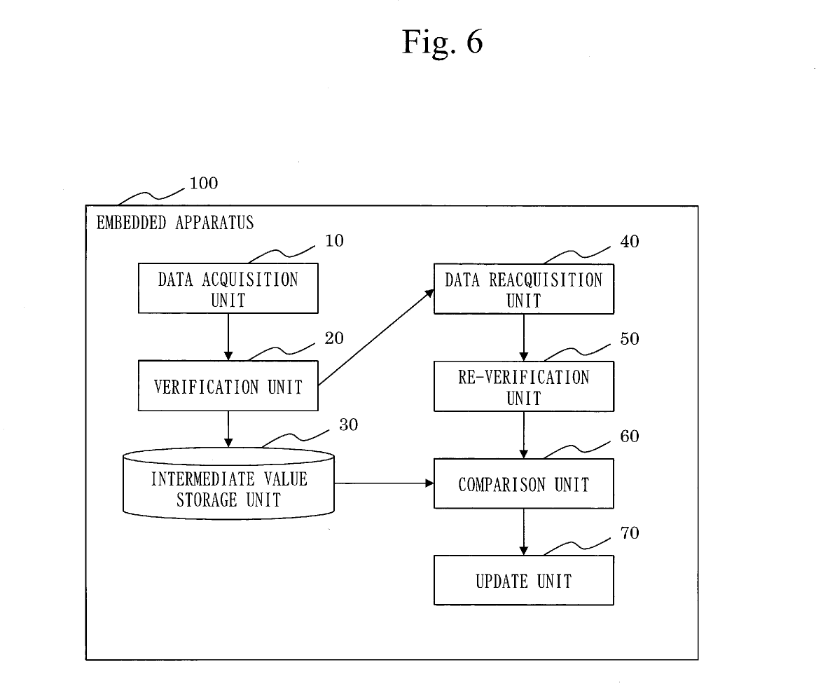

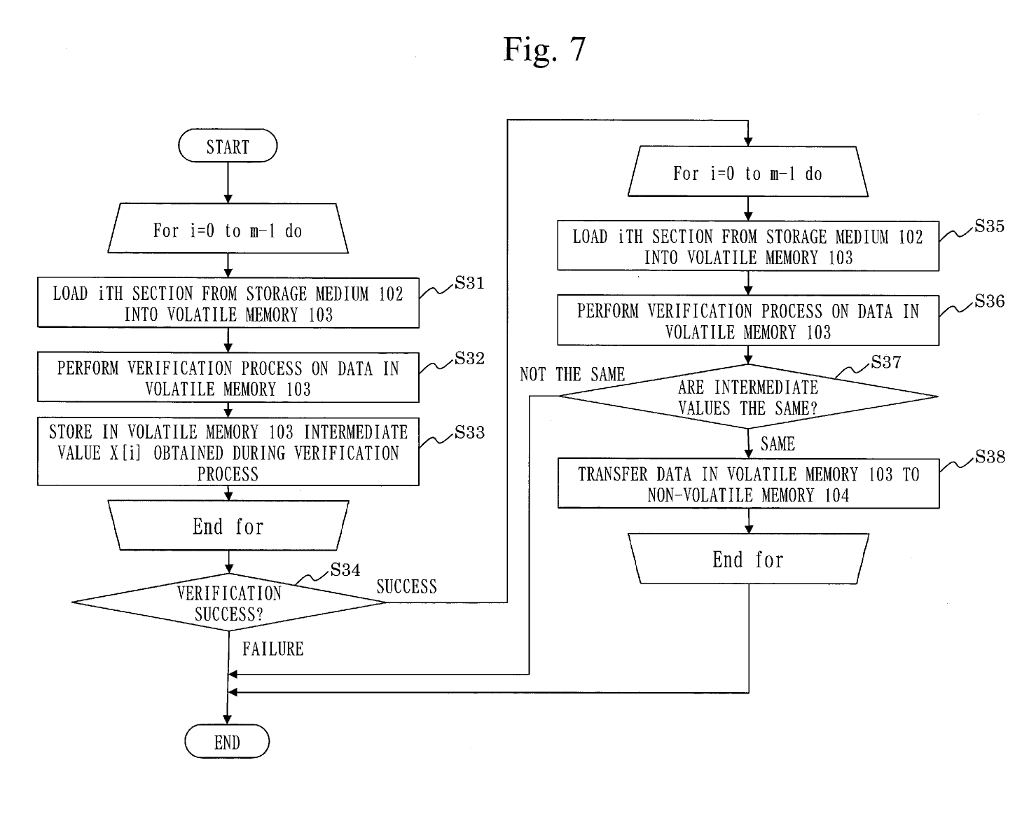

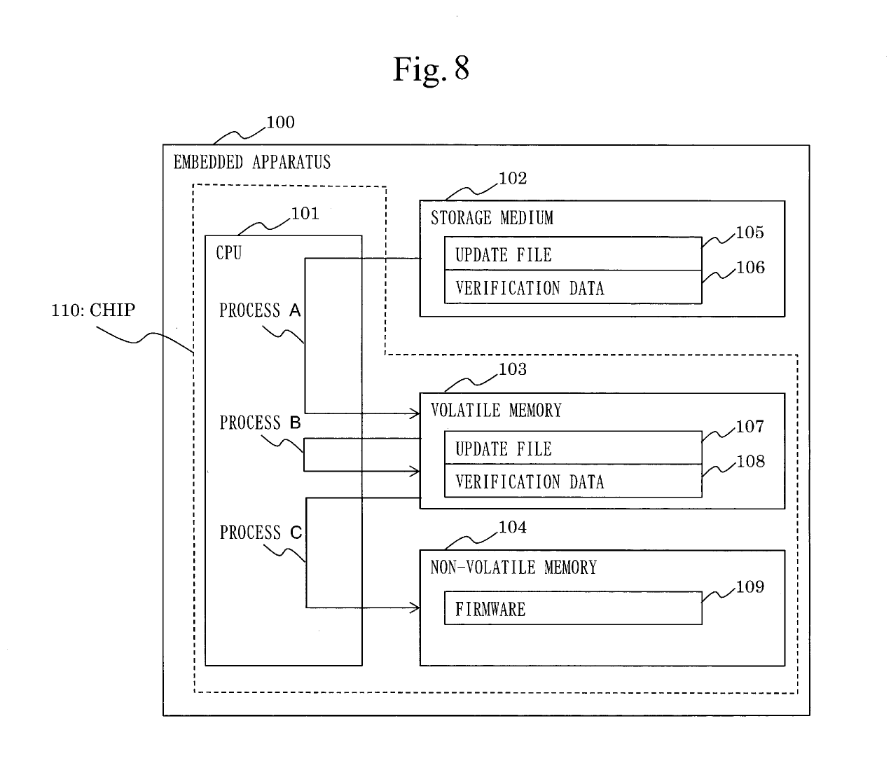

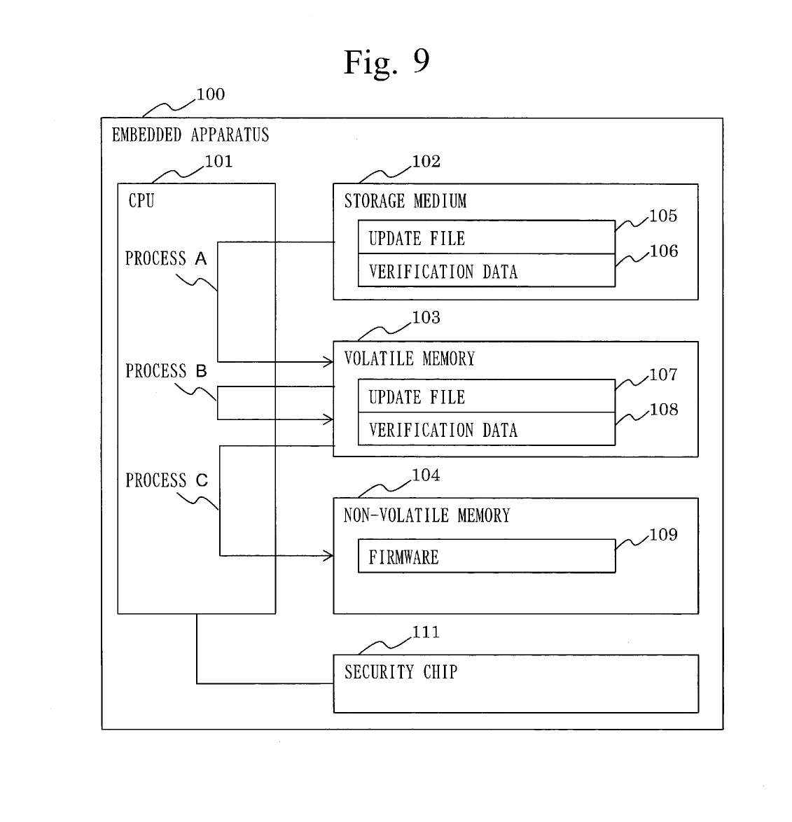

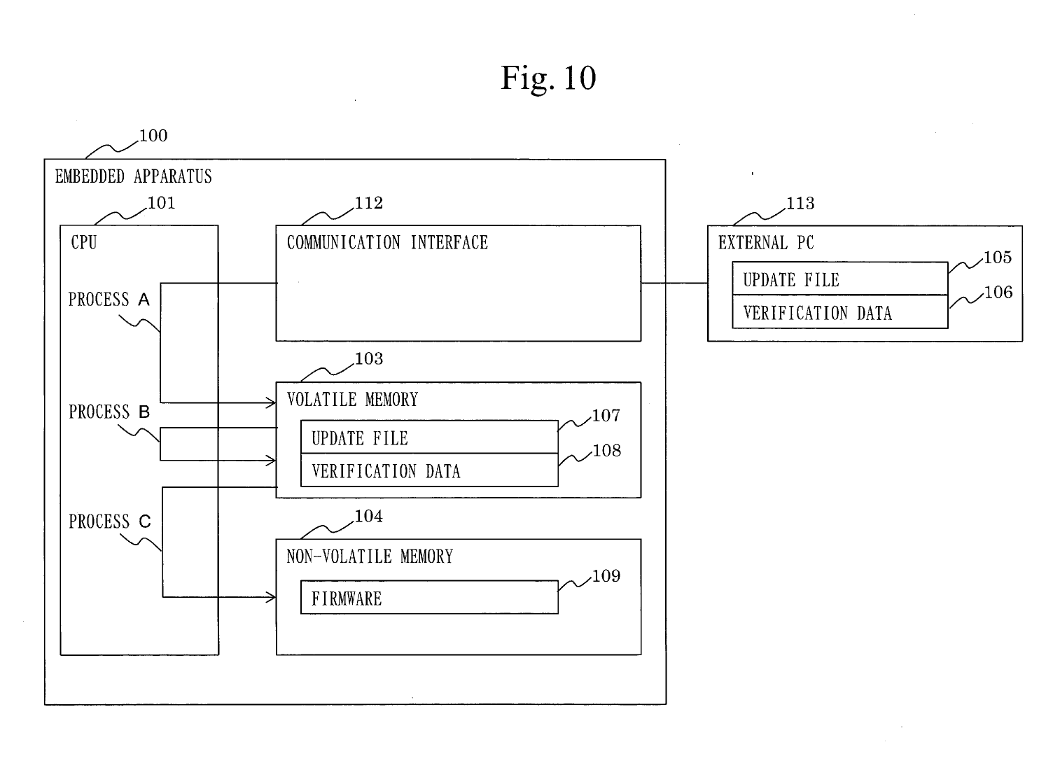

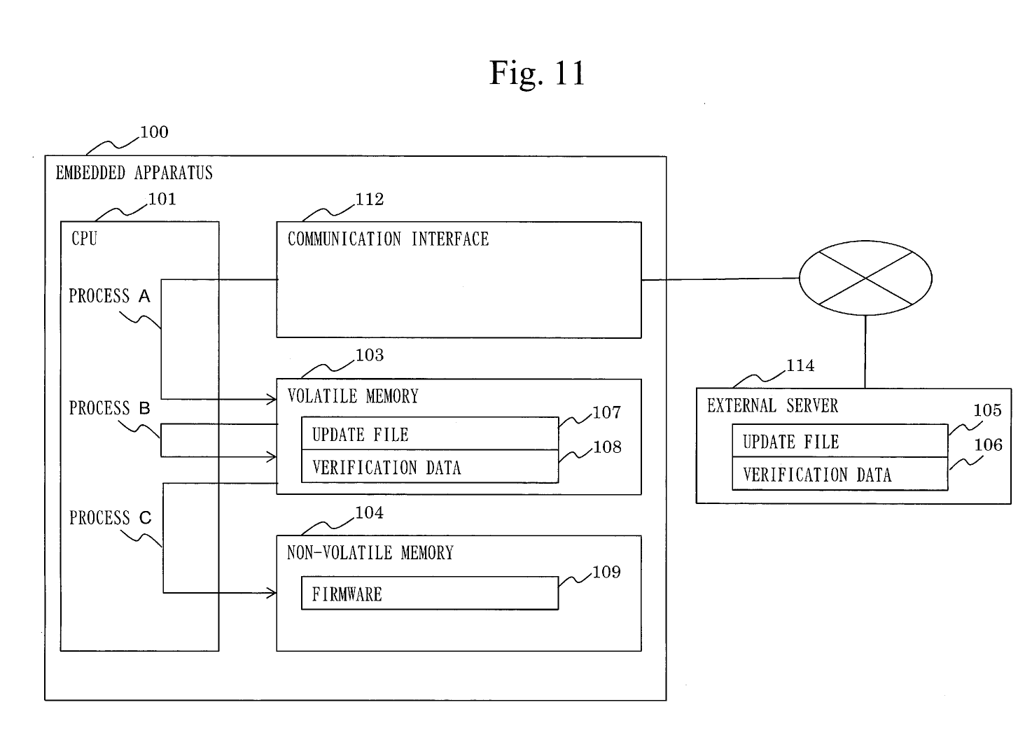

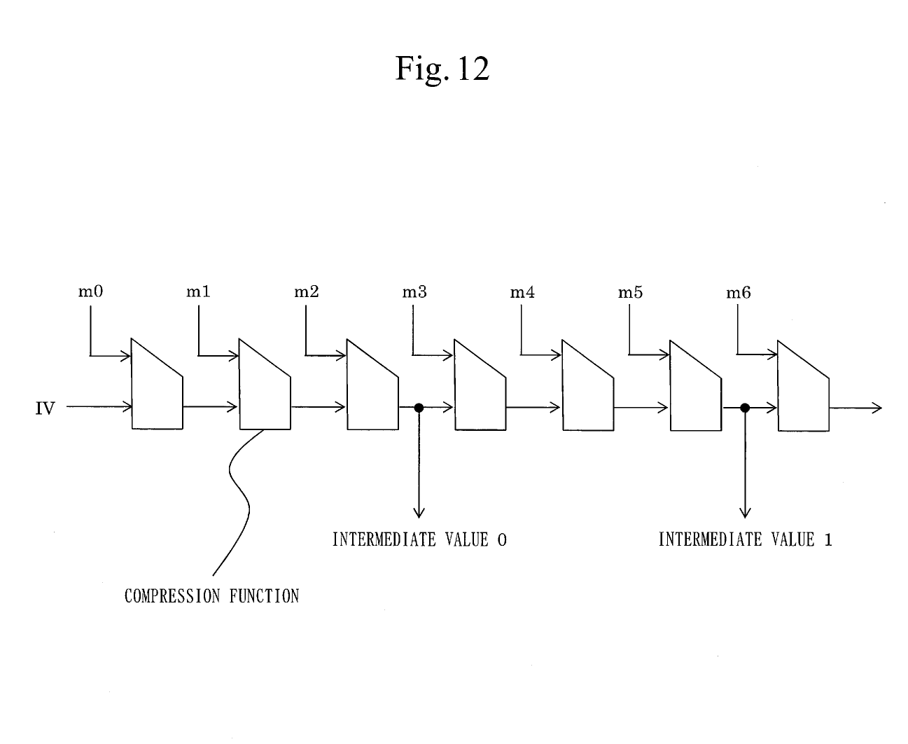

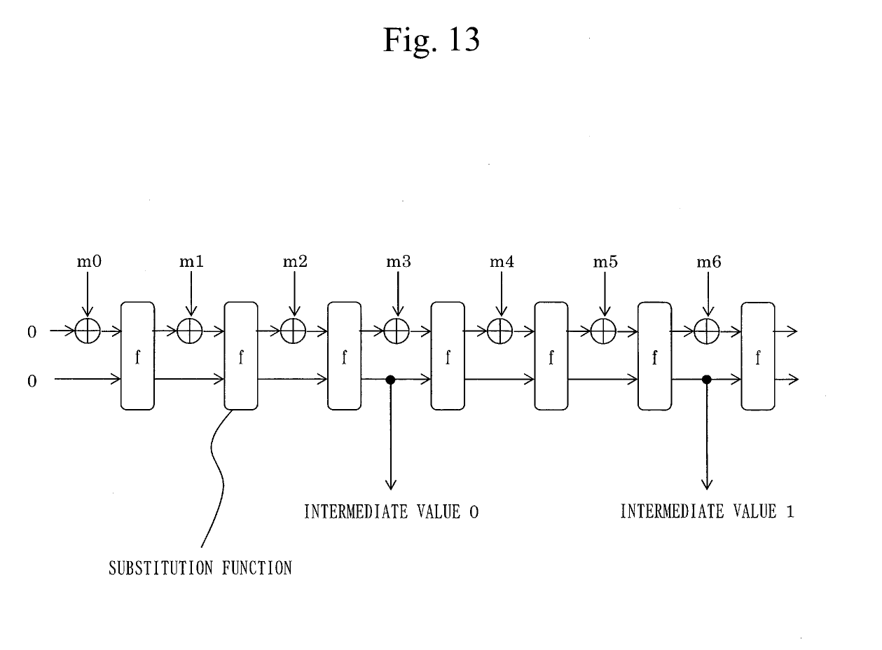

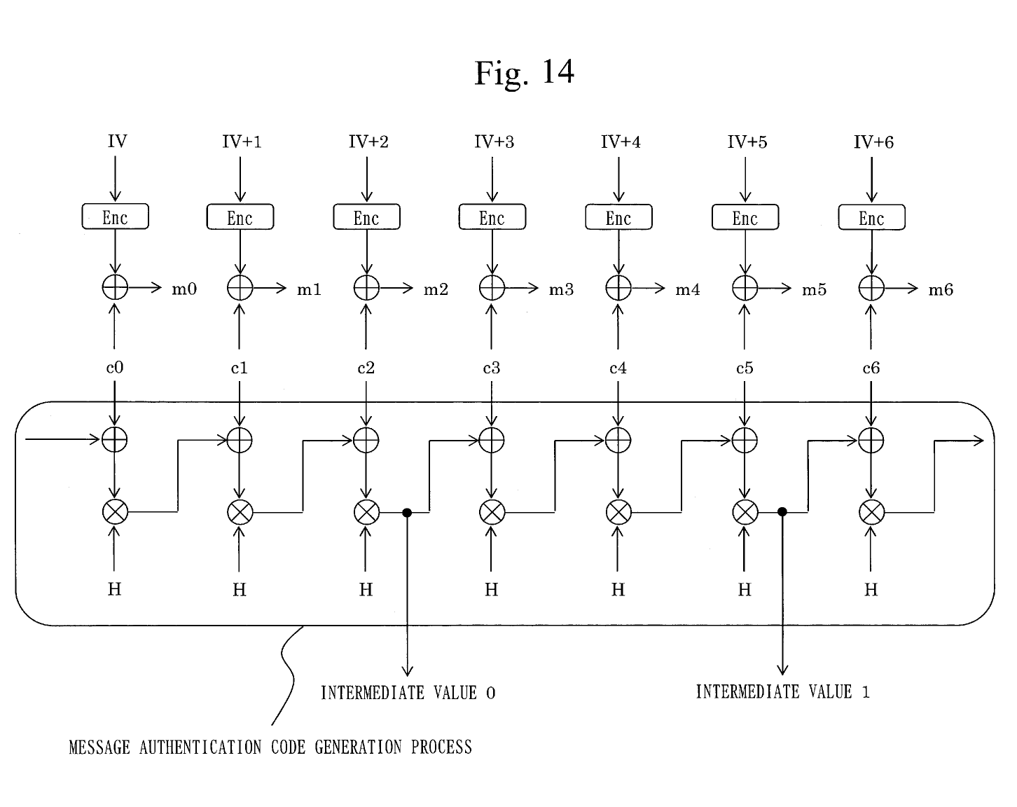

### BRIEF DESCRIPTION OF DRAWINGS

[FIG. 1] is a hardware configuration diagram of an embedded apparatus 100.

[FIG. 2] is a flowchart illustrating a procedure of alternative method 1.

[FIG. 3] is a diagram illustrating an outline of alternative method 2.

[FIG. 4] is a flowchart illustrating a procedure of alternative method 3. [FIG. 5] is a diagram illustrating an outline of a method according to Embodiment 1.

[FIG. 6] is a functional configuration diagram of the embedded apparatus 100 according to Embodiment 1.

[FIG. 7] is a flowchart illustrating a firmware update procedure of the embedded apparatus 100 according to Embodiment 1.

[FIG. 8] is a diagram illustrating another example of a hardware configuration of the embedded apparatus 100.

[FIG. 9] is a diagram illustrating another example of the hardware configuration of the embedded apparatus 100.

[FIG. 10] is a diagram illustrating another example of the hardware configuration of the embedded apparatus 100.

[FIG. 11] is a diagram illustrating another example of the hardware configuration of the embedded apparatus 100.

[FIG. 12] is a diagram illustrating examples of intermediate values.

[FIG. 13] is a diagram illustrating examples of the intermediate values.

[FIG. 14] is a diagram illustrating examples of the intermediate values.

### DESCRIPTION OF EMBODIMENTS

### Embodiment 1

FIG. 1 is a hardware configuration diagram of an embedded apparatus 100 (software update apparatus).

The embedded apparatus 100 includes a CPU 101, a storage medium 102, a volatile memory 103, and a non-volatile memory 104.

An end user supplies an update file 105 (update data) to the embedded apparatus 100 through the storage medium 102. The embedded apparatus 100 updates firmware 109 in the non-volatile memory 104 using the update file 105 stored in the storage medium 102.

When the tampering detection technology is applied to protection of the firmware, the end user supplies verification data 106 for detecting tampering of the update file 105 to the embedded apparatus 100, together with the update file 105.

The CPU 101 performs processes as follows when updating the firmware 109.

First, the CPU 101 executes a process A to copy the update file 105 and the verification data 106 that are present in the storage medium 102 into the volatile memory 103. The data copied will be referred to as an update file 107 and verification data 108.

Subsequently, the CPU 101 executes a process B to verify whether a value for verification obtained by performing a verification process on the update file 107 is the same as the verification data 108. The verification process is a process whereby the value for the verification is computed using an encryption process.

If a result obtained by performing the verification process is not the same as the verification data 108, it is recognized that the tampering has been detected. Then, the update process is interrupted and finished at that point. On the other hand, if the result of the verification is the same as the verification data 108, the CPU 101 executes a process C to write the update file 107 in the volatile memory 103 into the non-volatile memory 104, thereby updating the firmware 109.

By performing the above-mentioned processes at a time of the update, the firmware 109 stored in the non-volatile memory 104 can be prevented from being updated using the update file 107 that has been tampered with.

It is necessary for the volatile memory 103 to have a capacity for storing the update file 107 and the verification data 108 and for further executing the verification process in order to implement the above-mentioned method.

A description will be given about three alternative methods when the volatile memory 103 does not have a sufficient capacity. Then, after problems associated with the three methods have been described, a method according to Embodiment 1 will be described.

### Alternative Method 1

Alternative method 1 is a method whereby the firmware 109 stored in the non-volatile memory 104 is updated using the update file 107 without waiting for completion of a verification process and the embedded apparatus 100 is made to be inoperable when tampering is discovered in the verification process. When the embedded apparatus 100 is made to be inoperable, it becomes necessary for the firmware 109 to be updated again.

FIG. 2 is a flowchart illustrating a procedure of alternative method 1.

In alternative method 1, the update file 107 is divided into m sections by section (divided update data) unit in advance.

Then, the CPU 101 first initializes a flag to 1 (invalid) (S11).

Subsequently, the CPU 101 loads each section of the update file 107 into the volatile memory 103 (S12), performs the verification process on data of the section loaded in S12 (S13), and transfers the data of the section loaded in S12 to the non-volatile memory 104 (S14), in a loop from S12 to S14. This gradually updates the firmware 109.

Then, when the processes from S12 to S14 are completed for each of all the sections and a value for verification is computed, the CPU 101 reads the verification data 108. The CPU 101 compares the value for the verification obtained in the verification processes with the verification data 108 to determine whether or not the verification has succeeded (S15). If the verification is determined to have succeeded (success in S15), the CPU 101 sets the flag to 0 (success) (S16), and then finishes the procedure. On the other hand, if the verification is determined to have failed (failure in S15), the CPU 101 finishes the procedure as it is.

The embedded apparatus 100 checks whether or not the flag is 0 (success) when the embedded apparatus 100 is activated or the like. If the flag is not 0 (success), the activation is stopped, and the embedded apparatus 100 makes a response such as requesting the firmware 109 to be updated again.

In alternative method 1, however, the embedded apparatus 100 becomes inoperable when verification has failed. For that reason, alternative method 1 can be employed only when the embedded apparatus 100 may become temporarily inoperable.

Further, depending on an implementation method of the firmware 109, the entirety of a flag checking function may be overwritten at a time of the activation, so that flag checking may be circumvented. In this case, the embedded apparatus 100 will operate in a state where the firmware 109 has been fraudulently updated.

Further, depending on an implementation method of the verification process, a plaintext for each encrypted sentence of the update file 107 that has been altered may be written into the non-volatile memory 104. Information on the plaintext may therefore lead to decryption of encryption used for the verification process (refer to on line decryption misuse in Non-Patent Literature 2).

### Alternative Method 2

Alternative method 2 is a method whereby the verification data 108 is provided for each section of the update file 107, and verification is performed for each section.

FIG. 3 is a diagram illustrating an outline of alternative method 2.

As illustrated in (a) of FIG. 3, the format of the update file 107 is changed to provide, for each section, the verification data 108 for verifying the section. This allows the CPU 101 to independently execute a verification process for each section. Accordingly, the CPU 101 may sequentially perform the verification process for each section, and may perform writing into the non-volatile memory 104, starting from the section for which the verification process has been finished. As a result, data for which the verification process has not been completed may be prevented from being written into the non-volatile memory 104 to update the firmware 109.

In alternative method 2, however, an attack, in which the sections in the file are rearranged, as illustrated in (b) of FIG. 3, may be executed. Further, an attack, in which a part of the sections is replaced by an old version, as illustrated in (c) of FIG. 3, may be executed.

### Alternative Method 3

Alternative method 3 is a method whereby each section of the update file 107 is sequentially input for a verification process, as in alternative method 1, and when verification of the entirety of the update file 107 succeeds, each section of the update file 107 is acquired again to update the firmware 109.

FIG. 4 is a flowchart illustrating a procedure of alternative method 3.

In alternative method 3, the update file 107 is divided into m sections by section unit in advance, as in alternative method 1.

Then, the CPU 101 loads each section of the update file 107 into the volatile memory 103 (S21) and performs the verification process on data of the section loaded in S21 (S22), in a loop from S21 to S22.

Then, when the processes from S21 to S22 are completed for each of all the sections, and a value for the verification is computed, the CPU 101 reads the verification data 108. The CPU 101 compares the value for the verification obtained in the verification processes with the verification data 108 to determine whether or not the verification has succeeded (S23). If the verification is determined to have succeeded (success in S23), the CPU 101 transfers the procedure to S24. On the other hand, if the verification is determined to have failed (failure in S23), the CPU 101 finishes the procedure without updating the firmware 109.

If the verification is determined to have succeeded, the CPU 101 loads each section of the update file 107 into the volatile memory 103 again (S24), and transfers the data of the section loaded in S24 to the non-volatile memory 014 (S25), in a loop from S24 to S25. This gradually updates the firmware 109.

In alternative method 3, the firmware 109 may be updated after the verification of the entirety of the update file 107 has been finished.

In alternative method 3, however, it is not guaranteed that the update file 107 loaded for a first time in the loop from S21 and S22 has the same contents as the update file 107 loaded for a second time in the loop from S24 to S25. That is, to take an example, an attack becomes possible in which, using the storage medium 102 that has been manipulated, the update file 107 that has been altered is loaded only at a time of second-time loading.

### Method According to Embodiment 1

A method according to Embodiment 1 is a method whereby each section of the update file 107 is sequentially input for a verification process, and when verification of the update file 107 succeeds, each section of the update file 107 is acquired again from the storage medium 102 to update the firmware 109, as in alternative method 3. In the method according to

Embodiment 1, however, an intermediate value obtained when the verification process has been performed for the update file 107 loaded for a first time is stored. Then, the verification process is performed also for the update file 107 loaded for a second time. The intermediate value obtained is compared with the intermediate value stored to check that the update file 107 loaded for the first time and the update file 107 loaded for the second time have the same contents.

FIG. 5 is a diagram illustrating an outline of the method according to Embodiment 1.

Referring to FIG. 5, the update file 107 is divided into four sections 1 to 4. Each of the sections 1 to 4 has a size in which, in consideration of the capacity of the volatile memory 103, the verification process may be executed while storing data of one section.

First, the CPU 101 reads the section 1 to perform the verification process. At this point, the CPU 101 stores an intermediate value 1 obtained during the verification process. Subsequently, the CPU 101 reads the section 2 to perform the verification process. At this point, the CPU 101 stores an intermediate value 2 obtained during the verification process. Similarly, the CPU 101 sequentially reads each of the sections 3 and 4 to perform the verification process. The CPU 101 then stores intermediate values 3 and 4 obtained during the verification processes.

Then, the CPU 101 compares a value for verification obtained in the verification processes with the verification data 108 to determine whether or not the verification has succeeded.

If the verification is determined to have succeeded, the CPU 101 reads the section 1 again to perform the verification process, thereby obtaining an intermediate value 1′. The CPU 101 compares the intermediate value 1′ obtained with the intermediate value 1 stored to check that the intermediate value 1′ is the same as the intermediate value 1. Then, if it can be confirmed that the intermediate value 1′ is the same as the intermediate value 1, the CPU 101 updates the firmware 109 using the section 1. Subsequently, the CPU 101 reads the section 2 again to perform the verification process, thereby obtaining an intermediate value 2′. The CPU 101 compares the intermediate value 2′ obtained with the intermediate value 2 stored to check that the intermediate value 2′ is the same as the intermediate value 2. Then, if it can be confirmed that the intermediate value 2′ is the same as the intermediate value 2, the CPU 101 updates the firmware 109 using the section 2. Similarly, the CPU 101 sequentially reads each of the sections 3 and 4 as well, makes intermediate value comparisons, and then updates the firmware 109.

FIG. 6 is a functional configuration diagram of the embedded apparatus 100 according to Embodiment 1.

The embedded apparatus 100 includes a data acquisition unit 10, a verification unit 20, an intermediate value storage unit 30, a data reacquisition unit 40, a re-verification unit 50, a comparison unit 60, and an update unit 70.

Herein, the data acquisition unit 10, the verification unit 20, the intermediate value storage unit 30, the data reacquisition unit 40, the re-verification unit 50, the comparison unit 60, and the update unit 70 are each a program or software, for example, are stored in the non-volatile memory 104, and are each read and executed by the CPU 101. These units may be each a function that constitutes a portion of the firmware 109. Alternatively, these units may be each implemented by hardware such as a circuit or an apparatus.

FIG. 7 is a flowchart illustrating a firmware update procedure of the embedded apparatus 100 according to Embodiment 1.

The update file 107 is divided into m sections by section unit in advance.

Then, first, processes are sequentially performed for each section of the update file 107 in a loop from S31 to S33. Specifically, the data acquisition unit 10 loads one of the sections of the update file 107 stored in the storage medium 102 into the volatile memory 103 (S31). Subsequently, the verification unit 20 performs a verification process in the volatile memory 103, on data of the section loaded into the volatile memory 103 in S31 (S32). Then, the intermediate value storage unit 30 stores, in the volatile memory 103, an intermediate value obtained during the verification process performed in S32 (S33).

If the processes from S31 to S33 are completed for each of all the sections and a value for verification is computed, the data acquisition unit 10 reads the verification data 108 stored in the storage medium 102. The verification unit 20 compares the value for the verification obtained in the verification processes performed in S32 with the verification data 108 to determine whether or not the verification has succeeded (S34). If the verification is determined to have succeeded (success in S34), the verification unit 20 transfers the procedure to S35. On the other hand, if the verification is determined to have failed (failure in S34), the verification unit 20 finishes the procedure without updating the firmware 109.

If the verification is determined to have succeeded, processes are sequentially performed for each section of the update file 107 in a loop from S35 to S38. Specifically, the data reacquisition unit 40 loads the one of the sections of the update file 107 stored in the storage medium 102 into the volatile memory 103 (S35). Subsequently, the re-verification unit 50 performs the verification process in the volatile memory 103, on data of the section loaded in S35 (S36). Then, the comparison unit 60 compares an intermediate value obtained during the verification process performed in S36 with the intermediate value stored in the volatile memory 103 in S33 to determine whether or not the intermediate values are the same (S37). If the intermediate values are determined to be the same (same in S37), the update unit 70 updates the firmware 109 using the data of the section of the update file 107 read in S35 (S38). On the other hand, if the intermediate values are determined not to be the same (not the same in S37), the procedure is finished without updating the firmware 109.

As described above, in the method according to Embodiment 1, the firmware 109 is updated, using the section confirmed to have the same contents as the section that has been verified. Consequently, unlike in the case of alternative method 3, the embedded apparatus will not receive an attack in which, using the storage medium 102 that has been manipulated, the update file 107 that has been altered is loaded only at a time of second-time loading.

In the method according to Embodiment 1, each intermediate value is not stored in the non-volatile memory 104, and is not exposed outside the volatile memory 103. Thus, the intermediate value will not be read by an attacker. Consequently, an attack using the intermediate value will not be made.

Certainly, in the method according to Embodiment 1, the update file 107 is divided for each section, each section is loaded into the volatile memory 103, and the verification process is performed, as in alternative methods 1 to 3. Thus, even if the capacity of the volatile memory 103 is small, the verification process may be executed.

In the above-mentioned description, the embedded apparatus 100 is assumed to have a hardware configuration illustrated in FIG. 1.

As illustrated in FIG. 8, however, the embedded apparatus 100 may have a configuration including a chip 110 in which the CPU 101, the volatile memory 103, and the non-volatile memory 104 are mounted together.

Alternatively as illustrated in FIG. 9, the embedded apparatus 100 may have a configuration including a security chip 111, in addition to the configuration illustrated in FIG. 1. Then, it may be so arranged that the verification process is performed, using the security chip 111.

Alternatively, as illustrated in FIG. 10, the embedded apparatus 100 may have a configuration including a communication interface 112 in place of the storage medium 102. Then, the CPU 101 may acquire the update file 105 and the verification data 106 from an external PC 113 or the like through the communication interface 112 to store the update file 105 and the verification data 106 in the volatile memory 103. Alternatively, as illustrated in FIG. 11, the CPU 101 may acquire the update file 105 and the verification data 106 from an external server 114 or the like connected via the Internet or the like through the communication interface 112 to store the update file 105 and the verification data 106 in the volatile memory 103.

In the above-mentioned description, each intermediate value is set to just a value that is obtained during the verification process.

Herein, a Merkle-Damgard type hash function (refer to Non-Patent Literature 3) can be used as an encryption algorithm for the verification process. As illustrated in FIG. 12, the Merkle-Damgard type hash function includes a process of repeatedly computing a compression function. When the Merkle-Damgard type hash function is used as the encryption algorithm for the verification process, an output of the compression function of an appropriate stage number, for example, may be set to the intermediate value.

Alternatively, a sponge type hash function (refer to Non-Patent Literature 4) can be used as the encryption algorithm for the verification process. As illustrated in FIG. 13, the sponge type hash function includes a process of repeatedly computing a substitution function. When the sponge type hash function is used as the encryption algorithm for the verification process, an output of the substitution function of an appropriate stage number, for example, may be set to the intermediate value.

Alternatively, a message authentication code (refer to Non-Patent Literature 3) and a block cipher mode of operation with message authentication (refer to Non-Patent Literature 3) can be used as the encryption algorithm for the verification process. FIG. 14 illustrates Galois Counter Mode (refer to Non-Patent Literature 5). As illustrated in FIG. 14, the message authentication code and the block cipher mode of operation with message authentication include a process of repeatedly computing a same operation. When the message authentication code and the block cipher mode of operation with message authentication are used as the encryption algorithm for the verification process, an output of the operation of an appropriate stage number, for example, may be set to the intermediate value.

### REFERENCE SIGNS LIST

100: embedded apparatus, 101: CPU, 102: storage medium, 103: volatile memory, 104: non-volatile memory, 105, 107: update file. 106, 108: verification data, 109: firmware, 10: data acquisition unit, 20: verification unit, 30: intermediate value storage unit, 40: data reacquisition unit, 50: re-verification unit, 60: comparison unit, 70: update unit

1-5. (canceled)

6. A software update apparatus comprising:
processing circuitry
to sequentially acquire each of a plurality of divided update data, as first divided update data, obtained by division of update data for updating software;
to execute a verification process on the first divided update data;
to store a first intermediate value obtained during the verification process;
to sequentially acquire each of the divided update data again, as second divided update data, when the verification process is finished for each of the first divided updated data and verification of the update data succeeds;
to execute the verification process on the second divided update data; and
to update the software using the second divided update data when a second intermediate value obtained during the verification process and the first intermediate value are the same.

7. The software update apparatus according to claim 6,
wherein the processing circuitry compares a value computed by execution of the verification processes on all of the first divided update data with verification data to determine whether or not the computed value and the verification data are the same, thereby determining whether or not the verification of the update data has succeeded; and
wherein the processing circuitry sequentially acquires each of the divided update data again, as the second divided update data, when the verification of the update data is determined to have succeeded.

8. The software update apparatus according to claim 6,
wherein the software is stored in a first storage device;
wherein the first divided update data and the second divided update data are stored in a second storage device; and
wherein the verification processes on the first divided update data and the second divided update data stored in the second storage device are executed.

9. The software update apparatus according to claim 8,
wherein the first intermediate value is stored in the second storage device.

10. A non-transitory computer-readable storage medium storing a software update program to cause a computer to execute:
a data acquisition process to sequentially acquire each of a plurality of divided update data obtained by division of update data for updating software;
a verification process to execute the verification process on the divided update data acquired in the data acquisition process;
an intermediate value storage process to store an intermediate value obtained during the verification process executed in the verification process;
a data reacquisition process to sequentially acquire each of the divided update data again when the verification process is finished for each of the divided updated data and verification of the update data succeeds;
a re-verification process to execute the verification process on the divided update data acquired in the data reacquisition process; and
an update process to update the software using the divided update data acquired in the data reacquisition process when an intermediate value obtained during the verification process executed in the re-verification process and the intermediate value stored in the intermediate value storage process are the same.
